(19) United States
(12) Patent Application Publication
(10) Pub. No.: US 2014/0034157 A1
(43) Pub. Date: Feb. 6, 2014

(54) PASSIVE VACUUM RELIEF VALVE FOR ULTRA-LOW TEMPERATURE FREEZERS

(71) Applicant: Global Cooling, Inc., Athens, OH (US)

(72) Inventor: Yongrak Kwon, Athens, OH (US)

(73) Assignee: Global Cooling, Inc., Athens, OH (US)

(21) Appl. No.: 13/953,815

(22) Filed: Jul. 30, 2013

Related U.S. Application Data
(60) Provisional application No. 61/677,528, filed on Jul. 31, 2012.

(51) Int. Cl. F25D 29/00; F16K 21/04

(52) U.S. Cl. CPC F25D 29/00; F16K 21/04
USPC 137/511

(57) ABSTRACT

A passive vacuum relief valve for an ultra-low temperature freezer. A thermally conductive tube extends through a freezer cabinet wall and opens into the interior cabinet space. The tube also extends outwardly from the cabinet wall in thermal exposure to ambient air so that it can receive heat from the ambient air. A valve enclosure has a chamber opening into the tube and is also positioned in the ambient air. A check valve, preferably a ball type, is formed in the valve enclosure and is polarized in a direction permitting ambient air to flow through the chamber and the tube into the freezer cabinet. The exposed tube is passively heated by the ambient air and provides a thermal conduction path to the valve and to the portion of the tube extending through the freezer cabinet wall to prevent moisture from freezing and locking the valve and/or obstructing the tube.

### BACKGROUND OF THE INVENTION

This invention relates to ultra-low temperature (ULT) freezers of the type used for storing biological materials and more particularly relates to a vacuum relief valve for such freezers that allows the pressure inside of an ultra low temperature freezer to rapidly equilibrate with the ambient pressure after a user closes the freezer access door or other cabinet closure.

ULT freezers generally operate at temperatures from −70° C. to below −145° C. When the freezer cabinet door is opened, ambient air enters the interior space of the cabinet by convection and displaces cold air within the cabinet. When the door is closed, this warm ambient air is rapidly cooled to a low temperature and therefore, by Boyle's law, contracts and reduces the internal pressure within the cabinet. When this situation arises, a pressure differential across the door is established that makes the door difficult or impossible to open by a human user as a result of a large closing force generated by the pressure differential.

Typically, this problem has been solved by providing a vacuum relief valve that allows ambient air to enter the cabinet when the door is closed so that the pressure can equilibrate. Equilibration of the pressures on the opposite sides of the door avoids low pressures occurring within ULT freezers that would prevent the opening of the cabinet door, thereby making it easier to subsequently open the door. However, the vacuum relief valve requires a passage that opens at one end into the interior of the freezer cabinet and opens at the opposite end with the exterior ambient air surrounding the cabinet and has a valve interposed between those opposite ends. A valve is necessary because, in the absence of a valve in the passage, there would be a continuous convection flow into and out of the cabinet. Such a convection flow would continuously be carrying both heat and moisture into the cabinet resulting in excessive ice and snow buildup within the cabinet and around the stored materials and would increase the energy required to maintain the low temperature within the freezer cabinet.

However, the moisture contained by the ambient air also causes problems for vacuum relief valves. One such problem is that the moisture condenses and freezes around the valve and makes it inoperable because the valve is cooled to below 0° C. Another problem is that the moisture can freeze in the passage between the cabinet interior and the surrounding ambient atmosphere and eventually clog or entirely block the passage. The prior art solution to these problems is to provide a small electric heater in thermal connection with the vacuum relief valve to sufficiently warm the critical parts to prevent ice from forming and thereby prevent these problems. The difficulty with an electric heater is not only that it consumes electrical energy but also, if the heater malfunctions or electrical power is temporarily lost so that the heater becomes inoperable, the pressure differential across the door can no longer be equilibrated. That can result in a significant pressure differential buildup that prevents a human user from opening the door. Such a pressure locked door prevents insertion or removal of contents into or out of the freezer until maintenance can be performed.

Therefore, it is an object and feature of the present invention to provide a vacuum relief valve that does not depend upon the input to it of electrical or any other form of energy because it has no heater and therefore no potential for heater malfunction but is, nonetheless, sufficiently heated to prevent or melt ice within the vacuum relief valve, including within its passage between the interior and exterior of the freezer cabinet.

### BRIEF SUMMARY OF THE INVENTION

The invention is a passive vacuum relief valve for an ultra-low temperature freezer. Such a freezer has an interior storage space surrounded by insulated freezer cabinet walls and a closure for access to the interior storage space. The relief valve has a conducting tube of thermally conducting material extending into a freezer cabinet wall and opening into fluid communication with the cabinet's interior space. The tube also extends outwardly from the cabinet wall in thermal exposure to ambient air surrounding the freezer for receiving heat from the ambient air. A valve enclosure is attached to the tube and has a chamber opening into the tube and positioned in the ambient air. A check valve is attached to the valve enclosure and is polarized in a direction permitting ambient air to flow into the chamber and the tube and blocking reverse flow out of the chamber into the ambient air. This permitted air flow equalizes the pressure in the freezer cabinet with the atmospheric pressure.

### BRIEF DESCRIPTION OF THE SEVERAL VIEWS OF THE DRAWINGS

FIG. 1 is a view in perspective of a ultra-low temperature freezer cabinet with an embodiment of the invention mounted to the freezer cabinet.

FIG. 2 is a view in perspective from above the embodiment of the invention illustrated in FIG. 1.

FIG. 3 is another view in perspective from below the embodiment of the invention illustrated in FIG. 1.

FIG. 4 is a view in vertical axial section of the embodiment illustrated in FIG. 1 taken substantially along the line 4-4 of FIG. 2.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

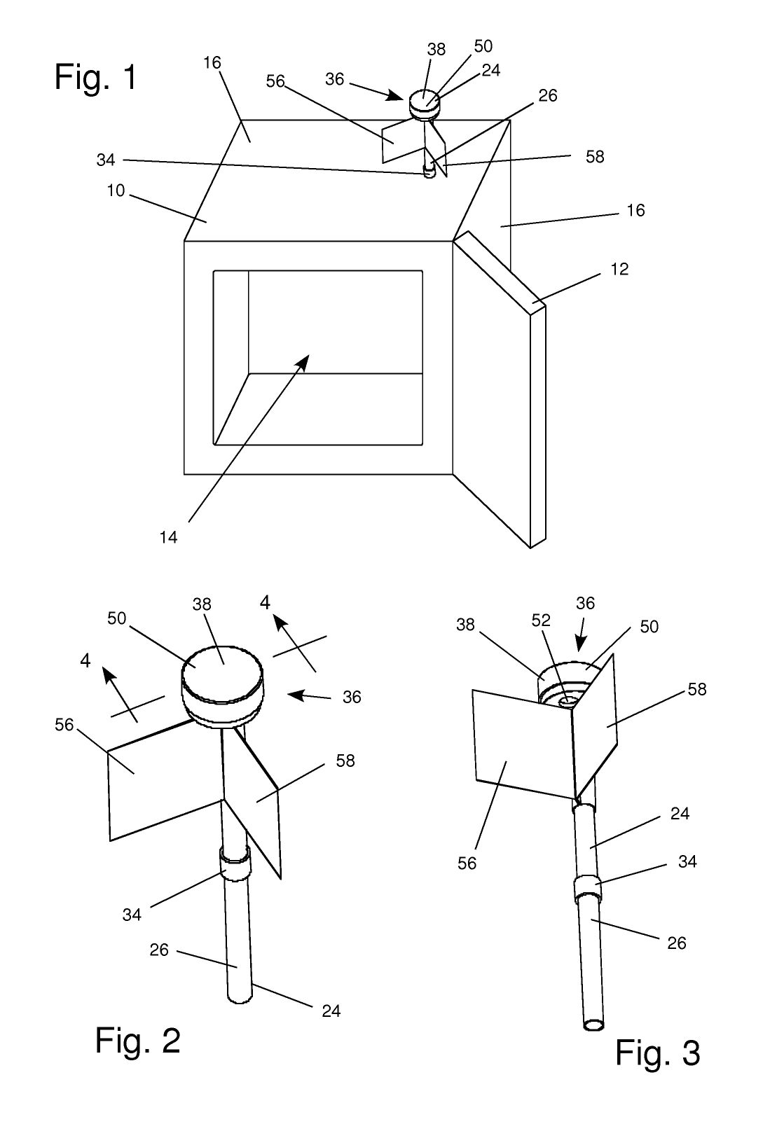

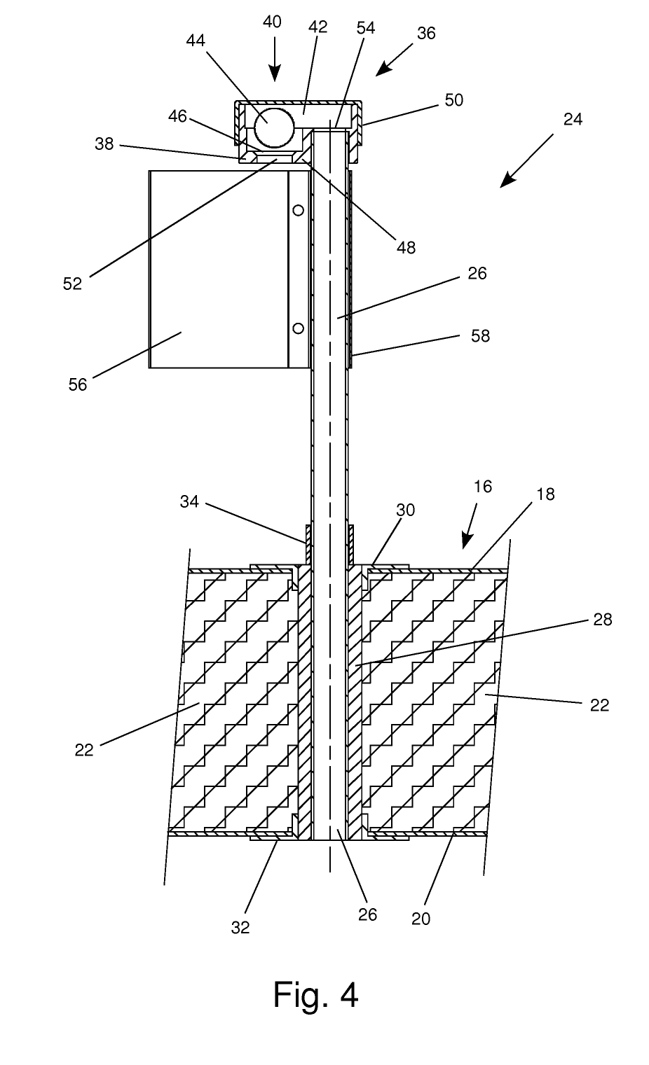

FIG. 1 shows a ULT freezer cabinet 10 having its hinged door 12 as a closure for, at times, permitting access to its interior storage space 14 within the surrounding insulated freezer cabinet walls 16 and, at times, enclosing the interior storage space 14. The door 12 is closed to allow the cooling equipment to bring the freezer to low temperature. The door 12 is sealed to the cabinet walls in order to prevent the flow of air currents into the freezer by convection but the seal permits the buildup of a pressure differential across the door 12. Referring to FIG. 4, the freezer cabinet walls 16 typically consist of metal walls, including an exterior metal wall 18 and an interior metal wall 20 separated by an insulating material 22.

FIG. 4 illustrates the details of the preferred embodiment of an entire passive vacuum relief valve 24. FIG. 1 illustrates the portion of the relief valve 24 that extends out from the freezer cabinet 16 and FIGS. 2 and 3 are exterior views of the entire pressure relief valve 24. The illustrated relief valve 24 is described with reference to all the figures. A thermally conducting tube 26, constructed of thermally conducting material such as copper or aluminum, extends through a port in the thermally insulated freezer cabinet wall 16 to the interior space 14. The tube 26 is illustrated with a circular cross section but can have any other cross-sectional shape and need only have an internal passage. The tube 26 opens into fluid communication with the interior space 14 and also extends outwardly from the cabinet wall in thermal exposure to ambient air surrounding the freezer cabinet 10 so that it can receive heat from the ambient air surrounding the cabinet 10. The heat from the ambient air outside the cabinet 10 can be conducted along the thermally conductive tube 26 and keep all parts of the vacuum relief valve at temperatures above 0° C., the freezing point of water. The tube 26 passes through the cabinet wall 16 including the cabinet wall thermal insulation 22. The tube 26 is directly surrounded by and passes through an insulating tube 28 made from a material such as polycarbonate or similar low thermally conducting material. The insulating tube 28 insulates the cabinet wall 16 from any heat that enters the vacuum release valve 24 during pressure equalization. Insulating tube 28 is supported by two collars 30 and 32 and is integrally fitted to the cabinet wall 16. A stopper 34 is a collar that fits snugly around the thermally conducting tube 26 and sets the distance that tube 26 may enter the cabinet.

A valve sub-assembly 36 is attached to the top end of the thermally conducting tube 26. The valve sub-assembly 36 includes a valve enclosure 38 and a check valve 40. The valve enclosure 38 is positioned in the ambient air and has a chamber 42 that opens into the tube 26. The valve enclosure 38 is spaced outwardly from the cabinet wall 16 to provide a length of thermally conducting tube 26 between the cabinet wall 16 and the valve enclosure 38 for absorbing heat from the ambient air. The valve enclosure 38 is preferably also constructed of thermally conductive material so that it too can absorb heat from the ambient atmosphere. The check valve 40 is attached to and part of the valve enclosure 38 and is polarized in a direction permitting ambient air to flow into the chamber 42 and the tube 26 and blocking reverse flow out of the chamber 42 into the ambient air. The preferred check valve 40 is a ball valve having a ball 44 above a check valve ball seat 46 for closing the valve by the gravitational force upon the ball when the ambient air pressure and the pressure within the interior storage space are equalized. The valve enclosure 38 is conveniently constructed of two parts, a base 48 with a cover 50. The cover 50 is sealed to the base 48 and seals the check-valve enclosure 38 so that air may only enter the valve enclosure 38 through a hole 52 in the check valve ball seat 46. The ball should have a low mass and preferably the ratio of the ball weight to the area within the circular seal between the ball and the ball seat and surrounding the hole 52 should be less than 0.025 lbs/in² for an access door of typical size. The hole 52 in the center of the check valve ball seat 46 is formed in the bottom wall of the base 48 and the base 48 is sealingly mounted to the tube 26 at a port 54 through the bottom wall of the base 48. As an alternative, the valve enclosure can be formed as a uniform extension of the tube 26 with a cover or cap at its exterior end.

Preferably, one or more thermally conductive heat exchanger fins are attached in thermal conductive connection to the thermally conducting tube 26 exteriorly of the freezer and exposed to the ambient air for increased heat conduction from the ambient air to the conducting tube 26. In the preferred embodiment, a pair of orthogonally arranged heat exchanger fins 56 and 58 are attached in thermal conductive connection to the conducting tube 26. They are made from a material such as copper or aluminum so that heat may be conducted from the environment, through the fins 56 and 58 and into the tube at a higher heat flow rate than in the absence of the fins 56 and 58. A heat exchanger structure in thermal connection to the tube 26 assures that natural or forced convection will provide sufficient ambient heat to enter the valve assembly at the required rate of heat transfer.

In operation, the insulating tube 28 thermally insulates the thermally conducting tube 26 so that its temperature is at all times above the melting point of ice, nominally 0° C. The heat for maintaining that temperature is provided from the environment by natural or forced convection to the fins 56 and 58 and the tube 26. With the vacuum release valve of the invention, the low pressure within the cabinet will allow the atmospheric pressure to lift the check-valve ball 44 and warm air from the environment will enter the vacuum release valve assembly and flow into the cabinet where it will equalize the pressures allowing the door to be opened almost immediately after being closed. The cracking pressure of the valve is designed to be small so that it does not contribute to the pressure difference across the door and make opening the door difficult. The vacuum release valve is also designed so that the air can pass through it without a large pressure drop in order to equilibrate the pressures as rapidly as possible. Any water in the air that would condense out onto the cold parts of tube 26 will not freeze because the thermally conductive tube 26 is always above 0° C. The condensed water will be blown into the cabinet by the inrushing air where it will freeze in the form of snow and other small ice particles thus avoiding any clogging problems in the air flow path along the vacuum release valve.

The vacuum release valve of the invention is passively heated by a thermal conduction path sized so that the thermal energy being conducted is sufficient to keep the valve from freezing. The thermal energy that is conducted into the valve is prevented from conducting into the cabinet by thermal insulation that separates the valve from interior thermally conducting surfaces. The valve employs a simple check valve to equilibrate the pressure within the cabinet.

An added advantage of this invention is that it is secured to the cabinet by a light, slidable fit and is therefore easily replaced, repaired or inspected. The valve assembly may be held in place by gravity or by some other convenient method. A ball valve seals by gravity or a low force-applying spring so that ambient air can enter the freezer cabinet with the least restriction and cracking pressure.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A passive vacuum relief valve for an ultra-low temperature freezer having an interior storage space surrounded by insulated freezer cabinet walls and a closure for access to the interior storage space, the relief valve comprising:
(a) a conducting tube of thermally conducting material extending into a freezer cabinet wall and opening into fluid communication with the interior space, the tube also extending outwardly from the cabinet wall in thermal exposure to ambient air surrounding the freezer for receiving heat from the ambient air and conducting the received heat along the tube to maintain the temperature along the tube above 0° C.;
(b) a valve enclosure having a chamber opening into the tube and positioned in the ambient air; and
(c) a check valve attached to the valve enclosure and polarized in a direction permitting ambient air to flow into the chamber and the tube and blocking reverse flow out of the chamber into the ambient air.

2. A passive vacuum relief valve in accordance with claim 1 wherein the thermally conducting tube extends inwardly entirely through the cabinet wall and is surrounded by thermal insulation within the cabinet wall.

3. A passive vacuum relief valve in accordance with claim 1 wherein the valve enclosure is spaced outwardly from the cabinet wall to provide a length of thermally conducting tube between the cabinet wall and the valve enclosure for absorbing heat from the ambient air.

4. A passive vacuum relief valve in accordance with claim 1 wherein the check valve is a ball valve having a ball above a valve seat for closing the valve by gravitational force upon the ball when ambient air pressure and pressure within the interior storage space are equalized.

5. A passive vacuum relief valve in accordance with claim 1 further comprising at least one thermally conductive heat exchanger fin attached in thermal conductive connection to the conducting tube exteriorly of the freezer and exposed to the ambient air for facilitating heat conduction from the ambient air to the conducting tube.

6. A passive vacuum relief valve in accordance with claim 1 wherein
(a) the thermally conducting tube extends inwardly entirely through the cabinet wall and is surrounded by thermal insulation within the cabinet wall; and
(b) the valve enclosure is spaced outwardly from the cabinet wall to provide a length of thermally conducting tube between the cabinet wall and the valve enclosure for absorbing heat from the ambient air and conducting heat along the tube into the cabinet wall in order to prevent the formation of ice within the tube.

7. A passive vacuum relief valve in accordance with claim 6 wherein the check valve is a ball valve having a ball above a valve seat for closing the valve by gravitational force upon the ball when ambient air pressure and pressure within the interior storage space are equalized.

8. A passive vacuum relief valve in accordance with claim 7 further comprising at least one heat exchanger fin attached in thermal conductive connection to the conducting tube exteriorly of the freezer and exposed to the ambient air for facilitating heat conduction from the ambient air to the conducting tube.
